(19) United States
(12) Patent Application Publication
(10) Pub. No.: US 2018/0035698 A1
(43) Pub. Date: Feb. 8, 2018

(54) AIR FRYING SYSTEMS AND METHODS

(71) Applicant: Spectrum Brands, Inc., Middleton, WI (US)

(72) Inventors: Gerald Joseph McNerney, Middleton, WI (US); Casey Aaron Klock, Fitchburg, WI (US); Boopalan Sampath, Madison, WI (US); Jacob Daniel Smith, Monona, WI (US)

(21) Appl. No.: 15/667,068

(22) Filed: Aug. 2, 2017

Related U.S. Application Data
(60) Provisional application No. 62/370,026, filed on Aug. 2, 2016.

(51) Int. Cl. A23L 5/10; A47J 37/06

(52) U.S. Cl. CPC A23L 5/17; A47J 37/0641; A23V 2002/00

(57) ABSTRACT

An air frying system including a housing defining an inner chamber, a food container positioned in the inner chamber, an air heating and circulation system in communication with the food container, and a steam supply and circulation system in communication with the food container, wherein the air heating and circulation system and the steam supply and circulation system are independently controllable for cooking a food product in the food container.

### CROSS-REFERENCE TO RELATED APPLICATIONS

This application claims priority to and the benefit of U.S. Provisional Patent Application No. 62/370,026, filed Aug. 2, 2016, the entire contents of which is incorporated herein by reference in its entirety.

### TECHNICAL FIELD

The present invention relates generally to cooking appliances for food, and more particularly to an air fryer for cooking food products in a manner that provides a taste, texture and appearance that is similar to what can be achieved by deep frying of those same food products.

### BACKGROUND

Deep frying or deep fat frying is a common method of preparing foods, particularly in the restaurant industry. Although large food items can be deep fried, such as fish fillets, multiple relatively small food items can also be deep fried, such as french fries, onion rings, and chicken strips. Such products can be prepared from frozen, refrigerated, room temperature, or partially cooked conditions, depending on the desired final food product.

One drawback to deep frying foods is the need to use large volumes of oil that must be maintained at relatively high temperatures to provide the desired cooking of the products. This hot oil requires special care by the handlers of the food products in order to prevent splashing or spilling of the oil during the cooking processes. In addition, the oil needs to be changed on a regular basis, which can be time-consuming and inconvenient. Although such oil changing is common in the restaurant industry, it can be particularly challenging for individual consumers who are using at-home deep fryers and do not have established procedures for cleaning and oil disposal.

In addition to the inconveniences of deep frying foods, many consumers are becoming more health conscious and are therefore minimizing or eliminating fried foods from their diets. However, some of these same consumers still desire the taste and texture of certain fried foods and are turning to the relatively new cooking process of air frying as a replacement cooking method to deep frying. Air frying eliminates a significant amount of oil and fat absorption into the food products while maintaining many of the desirable qualities of fried foods.

Commercially available air fryers generally require the use of a small amount of oil that is sprayed or otherwise applied to the food either before or after the food is added. Hot air is then circulated around the food products at a relatively high speed, such as with a fan, thereby cooking or “air frying” the food. Depending on the product being cooked and the particular air fryer being used, it may be necessary for a portion of the fryer (e.g., a basket) to be periodically shaken to more evenly cook the food items.

While the commercially available fryers may be adequate for certain food preparation processes, there is a desire in the industry to provide additional options for the air frying process to further improve the end food products and also simplify the air frying process for the consumer.

### SUMMARY

Air fryers or air frying systems of the invention provide the ability to add steam to food products before, after, and/or during the process of cooking the food with heated air alone, as would be used in prior art air fryers. With the systems and methods of the invention, steam cooking and air frying can be performed in a single device or air frying unit. For an example, steam can be used in an initial step of cooking a food product, such as with fresh cut french fries, and then the steam can be evacuated or allowed to exit the device. The air frying step can then take place to “crisp” or otherwise air fry the food products. However, these steps can instead be performed in a different order and/or one or more steps can be repeated, if desired. The amount of steam provided to the food products can be controlled and monitored, depending on the food being cooked and the desired qualities desired for the end food product. The timing of steam introduction to the system can also be controlled and monitored.

In one aspect of this invention, an air frying system is provided that comprises a housing defining an inner chamber, a food container positioned in the inner chamber, an air heating and circulation system in communication with the food container, and a steam supply system in communication with the food container. The food container can be a basket that has a mesh or other configuration having a plurality of openings that are in communication with at least one of the steam supply system and the air heating and circulation system. In an embodiment, the food container is rotatable about a horizontal axis during the cooking process.

With air fryers of the invention, the steam supply system can include a water tank and a heating element for heating water contained in the water tank to create steam, and can further include a steam tube extending from the water tank. The steam tube can include a distal end positioned to provide steam to a predetermined location within the inner chamber of the housing, which can be an area inside the food container or near the food container that provides the desired steam cooking for the food items.

### BRIEF DESCRIPTION OF THE DRAWINGS

The present invention will be further explained with reference to the appended Figures, wherein like structure is referred to by like numerals throughout the several views, and wherein;

FIG. 1 is a side view of an exemplary embodiment of an air frying system of the invention, wherein the internal components are visible, and which includes a rotating food basket and a steam supply system;

FIG. 2 is a top view of the air frying system of FIG. 1;

FIG. 3 is a front view of another exemplary embodiment of an air frying system of the invention, including a basket that can be manually or automatically rotated to agitate the food, and further including a steam supply system;

FIG. 4 is a side view of the air frying system illustrated in FIG. 3;

FIG. 5A is a side view of another exemplary embodiment of an air frying system of the invention, which includes a steam supply system;

FIG. 5B is a top view of an exemplary basket of this air frying system of FIG. 5A;

FIG. 6A is a side view of another exemplary embodiment of an air frying system of the invention that includes a steam supply system and a flexible silicone basket with a bottom plate that is moveable to agitate the food product in the basket;

FIG. 6B is a top view of an exemplary basket of the air frying system of FIG. 6A;

FIG. 7 is a side view of another exemplary embodiment of an air frying system of the invention that includes a steam supply system; and

FIG. 8 is a side view of another exemplary embodiment of an air frying system of the invention that includes a steam supply system and a removable water tank tray.

### DETAILED DESCRIPTION

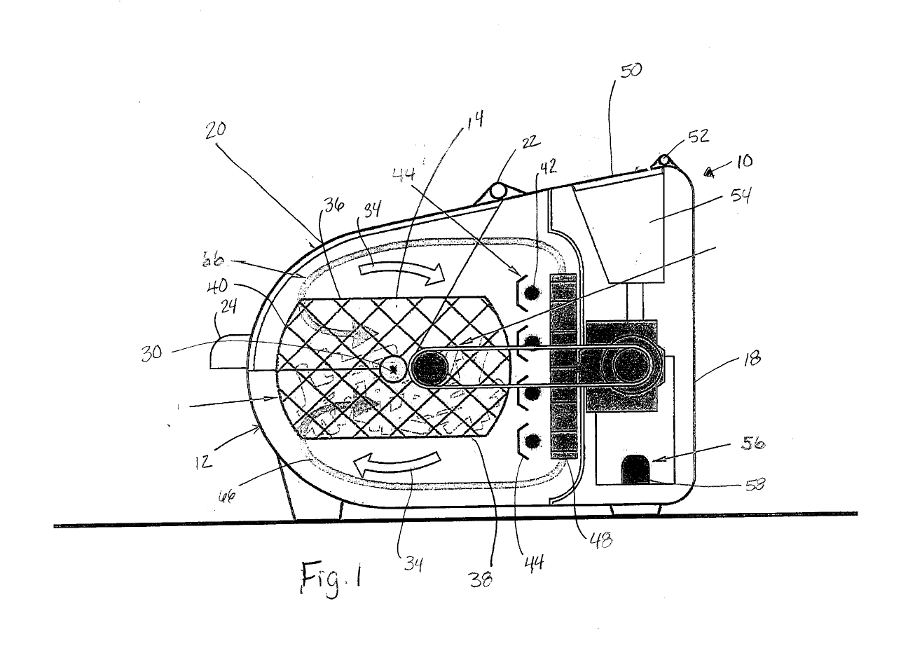

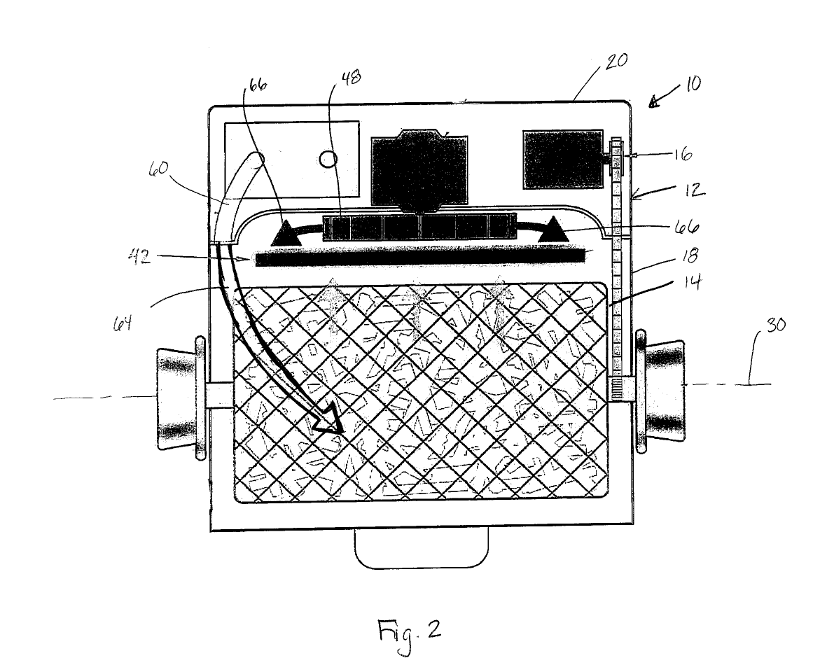

Referring now to the Figures, wherein the components are labeled with like numerals throughout the several Figures, and initially to FIGS. 1 and 2, a first exemplary configuration of an air fryer or air frying system 10 is illustrated. Air fryer 10 generally includes a housing 12 that surrounds the internal components of the fryer, including a rotatable food basket 14 that is driven by a motor 16, and an inner steam supply and circulation system. As will be described herein, air fryer 10 can selectively utilize traditional air frying components and/or steam for cooking food items that are placed in the food basket 14.

Housing 12 generally includes a shell with an inner cavity that includes a number of pieces to allow both for assembly of the housing and for access to certain portions of the housing. As illustrated, housing 12 includes a base or bottom portion 18 to which a food access door 20 is attached via a hinge 22. Food access door 20 further includes a handle 24 that can optionally be provided for ease in opening and closing. At least a portion of the door 20 can be transparent to allow for viewing of the food product as it is cooking, although all or portions of the door 20 can be opaque and/or translucent. It can be advantageous for the door 20 to be configured so that it remains in its open position during the loading and unloading of food product, and so that it locks or otherwise positively engages with the base portion 18 when it is closed. The door 20 is not necessarily hinged relative to the base portion 18, however, but can instead be removable and replaceable, such as can be accomplished with snap-fit components, latches, or other attachment features.

When food access door 20 is in its open position, an operator can access the food basket 14 that is positioned within housing 12. In an embodiment, food basket 14 is a mesh container having an inner area that is sufficiently large to hold a specified quantity of food. The mesh of the basket 14 can be relatively dense or loose, depending on the desired amount of access to air and steam that is desired within the basket itself. The basket 14 may instead be made of materials other than mesh, such as a solid material sheet with perforations, for example, or other materials. As shown, food basket 14 has a horizontal axis 30 about which it can rotate relative to the housing 12 during the food cooking process. One or more basket handles 32 can be provided on opposite sides of the housing 12 along the horizontal axis 30. These handles 32 are shown as round handles, although the handles can have a different size and shape than illustrated.

Movement of the basket 14 relative to the housing is shown as being a rotation about the horizontal axis 30 in a direction represented by arrows 34 (shown in FIG. 1). The motion can be reversible so that the basket 14 can also be rotated in the opposite direction. In any case, the basket 14 is designed so that it can freely rotate within housing 12 with sufficient clearance, wherein the basket configuration shown includes upper and lower opposite flat surfaces 36, 38, respectively, and curved ends 40 extending between them. The basket 14 can instead have a different configuration (e.g., a different shape and/or size) that allows for rotation generally as described. Rotation of the food basket 14 about the axis 30 can be driven by motor 16 that includes a belt or a gearing system. The motor 16 is preferably controllable by the operator to provide the desired speed of rotation for the basket 14. Alternatively, the food basket 14 can be manually rotated to agitate the food contained in the basket.

Air fryer 10 further includes at least one heater element 42, which is shown as an elongated horizontal member in FIG. 2. In this embodiment, four heater elements 42 are used, but more or less than four heater elements can be used. The heater elements 42 can include quartz tube heaters, wound mica heaters, halogen tube heaters, or other types of heaters (e.g., tubular heaters), such as those commercially available under the trade name “Calrod,” for example. In an exemplary embodiment, the heater elements 42 are provided as tubular heaters (e.g., electric heaters) that are used to produce radiant heat within the housing 12. A fan 48 (e.g., a centrifugal fan) is provided generally adjacent to the heater elements 42 to circulate the heated air through the housing 12. One or more of the heater elements 42 can be provided with a shield 44 that at least partially screens infrared radiation from exiting through any clear portion provided for the food access door 20.

Housing 12 further includes a water fill door 50 that is adjacent to the food access door 12. Water fill door 50 is attached via a hinge 52 to the base portion 18 in order to provide an operator with access to an inner water reservoir 54. Water fill door 50 can also be provided with a handle, recess, or other feature that allows an operator to easily move it to access the water reservoir 54, when desired. Inner water reservoir 54 is fluidly connected to a water tank 56 that sits near the bottom of the housing 12. In this way, the water tank 56 will be gravity fed from the water reservoir 54 that is positioned generally above it. Water tank 56 is configured such that steam is produced when its contents are sufficiently heated. This may be accomplished via an immersion boiler 58 positioned within the water tank 56, for example.

A steam tube 60 (see FIG. 2) extends from the water tank 56 and is positioned so that steam exiting the water tank 56 is provided to a preselected location within the housing 12 for a desired steam flow path. For example, steam can exit steam tube 60 at an end of the tube in the direction illustrated generally in FIG. 2 with arrow 64. By positioning the exit point of the steam tube in a desired location, steam can enter the food basket 14 through the openings in the mesh at a predetermined flow rate, pressure, and the like, to provide the cooking benefits provided by the steam. In an exemplary method of using the air frying system of the invention, the steam system can be used first to apply steam to the food product, and then the use of steam can be stopped by turning off the steam system. The steam can then be evacuated or allowed to dissipate, after which hot air can be applied in an air frying type of operation.

Although the above description is directed to one configuration for creating and supplying steam to the air frying systems, the stem generation and transmission can be provided in a number of alternative ways. In one example, a boiler is used to heat water that can be transmitted through a tube that is positioned in the same chamber. In another example, a steam pump can be used to direct a volume of steam into the air frying system. In yet another example, the water is not heated but is instead atomized then injected into the cavity so that no boiler or heater is needed.

When using the air frying portion of the system, the fan 48 directs air generally around the top and bottom of inner volume of the housing 12, as shown by arrows 66. The speed of the fan 48 is controllable to allow for adjustment of the movement of the heated air along its path. The speed of this fan 48 can be directly or indirectly correlated to the amount of steam being injected into the food basket 14 (which may be zero or negligible, in the case where the steam portion of the system has been turned off) in order to achieve a desired cooking of the food product. The air fryer 10 can be provided with automatic and/or manual settings to adjust these parameters.

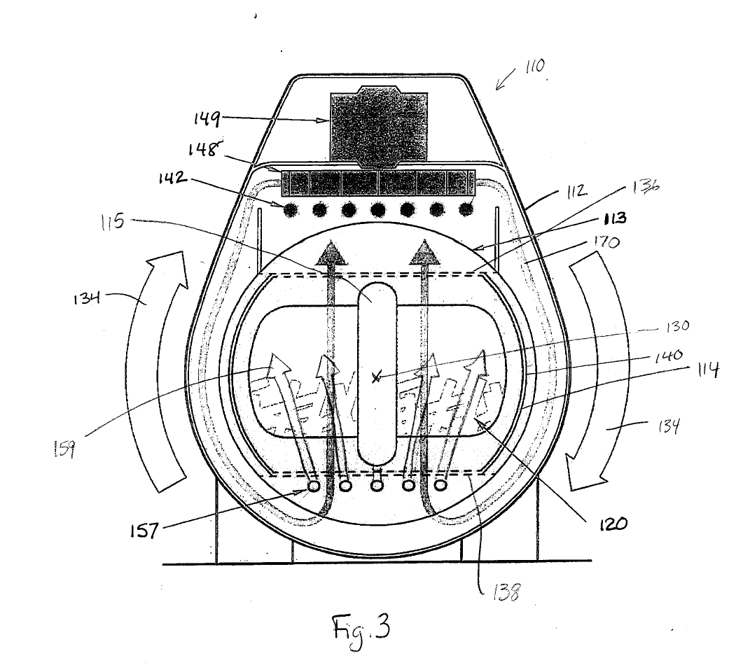

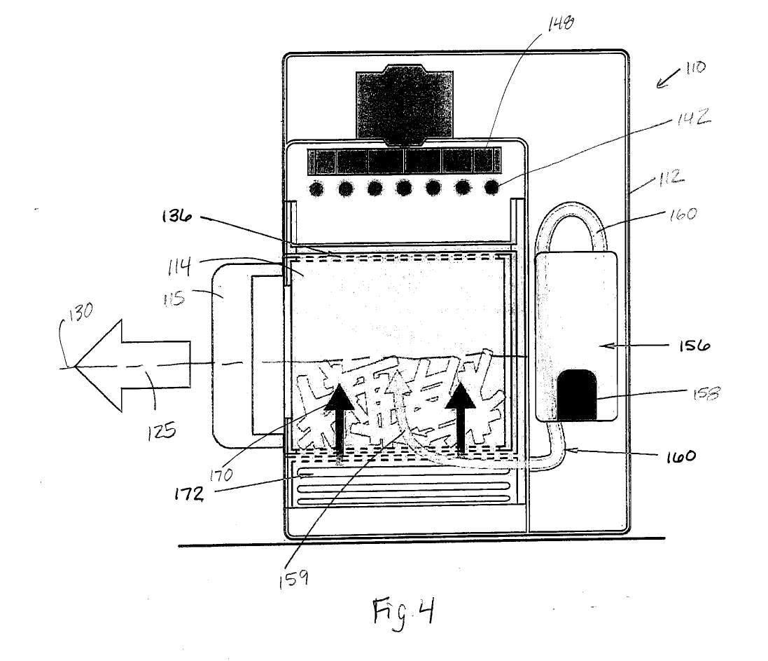

FIGS. 3 and 4 illustrate another exemplary embodiment of an air fryer 110 of the invention. Air fryer 110 generally includes a housing 112 that surrounds the internal components of the fryer, including a food basket drawer 114 within a rotatable carriage 113, and an inner steam supply and circulation system. As will be described below, air fryer 110 can utilize traditional air frying components and/or steam for cooking food items that are placed in the food basket drawer 114.

Housing 112 is a shell having one or more pieces to allow both for assembly of the housing and for access to certain portions of the housing. In this embodiment, rotatable carriage 113 is positioned within the housing 112, and the basket drawer 114 is slideable into the carriage 113. The drawer 114 can be provided with a handle 115, which is preferably accessible for grasping by a user. As shown in FIG. 4, the drawer 114 is removable from the carriage 113 by moving it in a direction indicated by arrow 125.

At least a portion of the housing 112 adjacent to the basket drawer 114 can be transparent (e.g., through window 120) to allow for viewing of the food product as it is cooking, although all or portions of the housing 112 in that area can be opaque and/or translucent. In order to provide access to the food drawer 114, there can be a hinged door or cover in that area, although an outer surface of the food drawer 114 itself can also serve the purpose of providing the outer cover of the housing 112 in that area.

Food drawer 114 is a container having an inner area that is sufficiently large to hold a specified quantity of food. As shown, the carriage 113 into which food drawer 114 is slideable has a horizontal axis 130 (extending outwardly from the page in FIG. 3) about which it can rotate relative to the housing 112 during the food cooking process. Movement of the carriage 113 relative to the housing 112 is shown as being a rotation about the axis 130 in the direction of arrows 134. The motion can be reversible so that the carriage 113 can also be rotated in the opposite direction. In any case, carriage 113 is designed so that it can freely rotate within housing 112. Rotation of the carriage 113 about the axis 130 can be driven by a motor that includes a belt or a gearing system. The motor is preferably controllable by the operator to provide the desired speed of rotation for the carriage 113. Alternatively, the carriage 113 can be manually rotated to agitate the food contained in the basket.

With regard to the food drawer 114 within the carriage 113, the illustrated exemplary configuration includes upper and lower opposite flat surfaces 136, 138, respectively, and curved ends 140 extending between them. The food drawer 114 can instead be configured differently, but should be easily slideable in and out of the carriage 113. It is noted that the upper and lower surfaces 136, 138 can be a mesh or perforated material that allows for air and steam movement through the food product contained therein. The mesh or perforations of the basket 114 can be relatively dense or loose, depending on the desired amount of access to air and steam that is desired within the basket itself.

Air fryer 110 further includes at least one heater element 142. In this embodiment, seven heater elements 142 are used, but more or less than seven heater elements can be used. The heater elements 142 can include quartz tube heaters or other types of tubular heaters, as described above relative to FIGS. 1 and 2. A fan 148 (e.g., a centrifugal fan with a motor 149) can also be provided generally adjacent to the heater elements to circulate the heated air.

Air fryer 110 includes a steam supply system that includes a heated water tank 156 that provides steam to the food system drawer 114 through at least one steam hole 157 (see FIG. 3) positioned below the food drawer 114. Water tank 156 is configured such that steam is produced when its contents are sufficiently heated. This may be accomplished via an immersion boiler 158 positioned within the water tank 156, for example. The system is further configured so that steam exits the water tank 156 in preselected location(s) to provide a desired steam flow path. The initial movement of the steam from the water tank 156 is via a steam tube 160 that is in communication with the steam holes 157. For example, five steam holes 157 can provide for five locations of injecting steam into the food drawer 114 in the direction illustrated generally in FIG. 3 with arrows 159. In this way, steam can enter the food drawer 114 through the openings in the mesh at a desired flow rate, pressure, and the like to achieve the cooking results provided by the steam.

The fan 148 directs air generally downward and then upward along the perimeter of the housing 112 and through the food drawer 114, as shown by arrows 170, which may occur before, during, or after steam is being injected into the food drawer 114. In particular, hot air can be pulled up through the food in the food drawer 114 and pushed out along the perimeter of the device around the basket drawer 114. Air can enter the bottom of the carriage 113 via vents 172 (see FIG. 4) in the bottom of the carriage 113, for example. The speed of the fan 148 is controllable to allow for adjustment of the movement of the heated air along its path. The speed of this fan 148 can be directly or indirectly correlated to the amount of steam being injected into the food drawer 114 (which may be zero or negligible) in order to achieve a certain cooking of the food product. The air fryer 110 can be provided with automatic and/or manual settings to adjust these parameters.

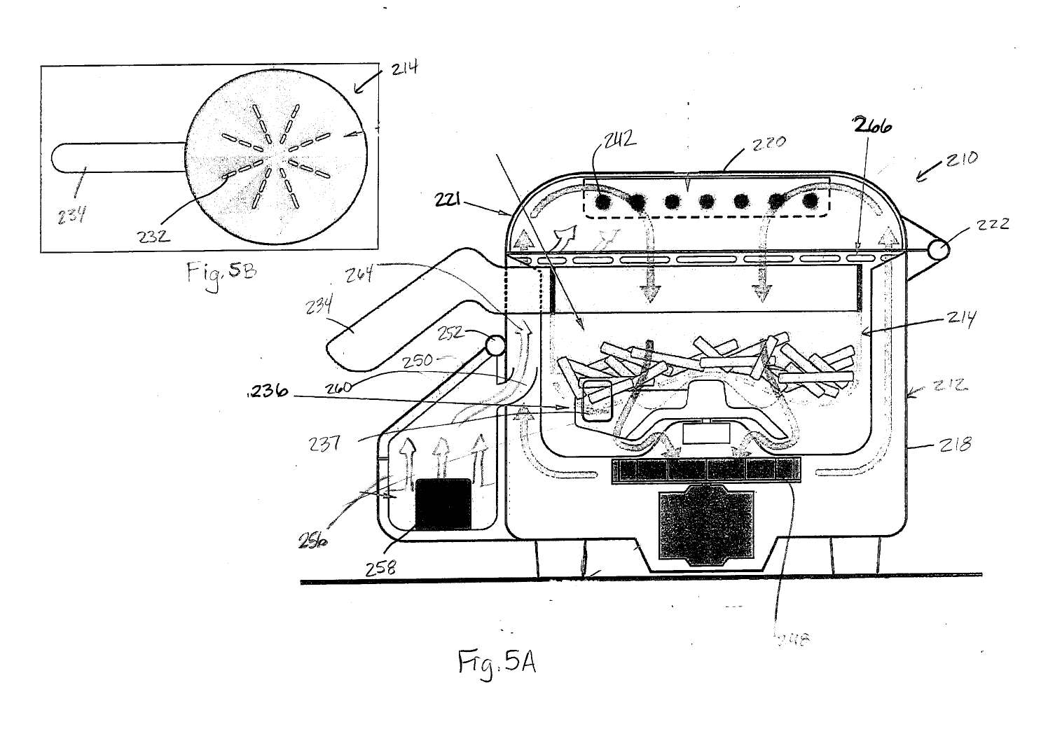

FIGS. 5A and 5B illustrate another exemplary embodiment of an air frying system 210 of the invention. Air fryer 210 generally includes a housing 212 that surrounds the internal components of the fryer, including a food basket 214 that is deformable to agitate the food contained therein, and an inner steam supply and circulation system. As will be described herein, air fryer 210 can utilize traditional air frying components and/or steam for cooking food items that are placed in the food basket 214.

Housing 212 is a shell that can include a number of pieces to allow both for assembly of the housing and for access to certain portions of the housing. As illustrated, housing 212 includes a base portion 218 to which a food access door or cover 220 is attached via a hinge 222. Food access door 220 can optionally include a handle, recess, or other feature for ease in opening and closing. At least a portion of the door 220 can be transparent (e.g., through a window 221) to allow for viewing of the food product as it is cooking, although all or portions of the door 220 can be opaque and/or translucent. It can be advantageous for the door 220 to be configured so that it can remain in its open position during the loading and unloading of food product, and so that it locks or otherwise positively engages with the base portion 218 when it is closed. The door 220 does not necessarily need to be hinged relative to the base portion 218, however, but can instead be removable and replaceable, such as can be accomplished with snap-fit components, latches, or other attachment features.

When food access door 220 is in its open position, an operator can access the food basket 214 that is positioned within housing 212. Food basket 214 (see FIG. 5B) includes at least a portion that is made of a deformable sheet-like material (e.g., a silicone sheet) having multiple perforations 232. An embodiment of food basket 214 includes an extending handle 234 that can be grasped by the user to insert and remove the basket 214 from the housing 212. In this embodiment, the handle 234 will extend outside the housing 212 when the basket 214 is positioned therein.

Air fryer 210 further includes a rotating arm 236 positioned beneath the food basket 214. The rotating arm 236 includes a roller 237 that pushes against the bottom of the basket to deform it in the area of the roller (which is moving) and agitating the food contained in the food basket 214. Rotation of the arm 236 can be driven by a motor that preferably controllable by the operator to provide the desired amount of agitation for the basket 214. Alternatively, arm 236 and/ or the roller can be manually activated to agitate the food contained in the basket.

Air fryer 210 further includes at least one heater element 242. In this embodiment, seven heater elements 242 are shown in the cover 220 of the housing 212; however, more or less than seven heater elements can be used. The heater elements 242 can include quartz tube heaters or other types of tubular heaters, such as those described above relative to FIGS. 1 and 2, or other types of heaters. A fan 248 (e.g., a centrifugal fan) can also be provided generally adjacent to the heater elements to circulate the heated air.

Housing 212 further includes a water fill door 250 at its lower area. Water fill door 250 is attached via a hinge 252 to the base portion 218 in order to provide an operator with access to an inner water tank 256. Water fill door 250 can also be provided with a handle, recess, or other feature that allows an operator to

access the water tank 256, when desired. Water tank 256 is configured so that steam is produced when its contents are sufficiently heated. This may be accomplished via an immersion boiler 258 positioned within the water tank 256, for example.

A steam tube 260 extends from the water tank 256 and is positioned so that steam exiting the water tank 256 is supplied to a preselected location within the housing 212 that provides a desired steam flow path. For example, steam can exit steam tube 260 at an end of the tube in the direction illustrated generally in FIG. 5 with arrow 264.

The fan 248 directs air out of vents 266, either before, after, or during the time that steam is being directed through the food basket, as shown in the illustration. The speed of the fan 248 is controllable to allow for adjustment of the movement of the heated air along its path. The speed of this fan 248 can be directly or indirectly correlated to the amount of steam being produced in order to achieve a certain cooking of the food product. The air fryer 210 can be provided with automatic and/or manual settings to adjust these parameters.

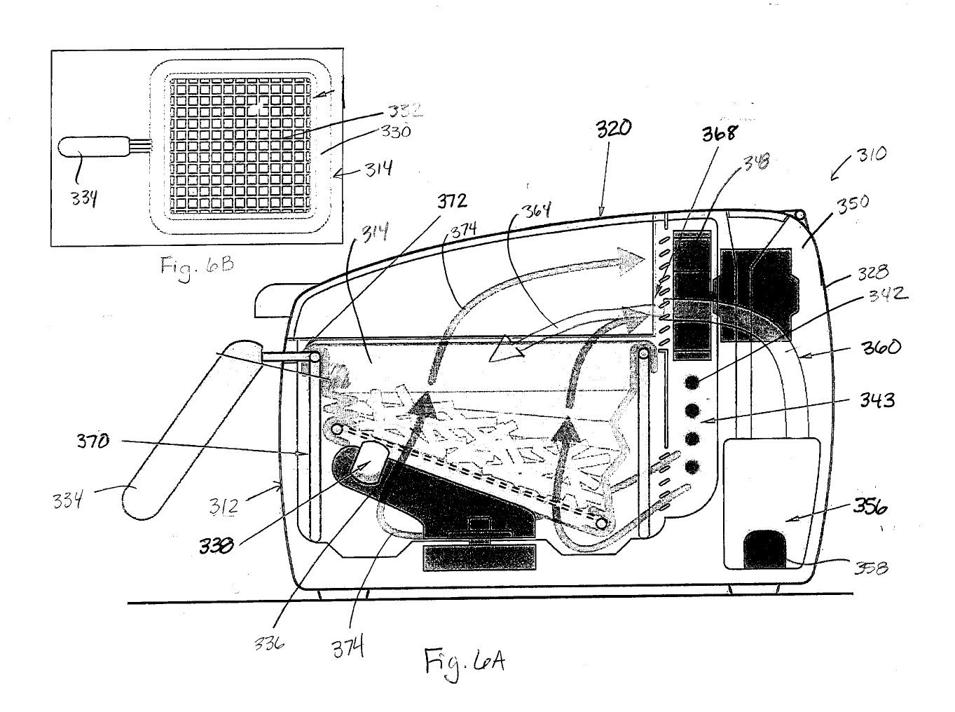

FIG. 6 illustrates another exemplary embodiment of an air frying system 310 of the invention. Air fryer 310 generally includes a housing 312 that surrounds the internal components of the fryer, including a food basket 314 that is deformable to agitate the food contained therein, and an inner steam supply and circulation system. As will be described below, air fryer 310 can utilize traditional air frying components and/or steam for cooking food items that are placed in the food basket 314.

Housing 312 is a shell that includes a number of pieces to allow both for assembly of the housing and for access to certain portions of the housing. As illustrated, housing 312 includes a base portion 318 to which a food access door 320 is attached. Food access door 320 can optionally include a handle, recess, or other feature for ease in opening and closing. At least a portion of the door 320 can be transparent to allow for viewing of the food product as it is cooking, although all or portions of the door 320 can be opaque and/or translucent.

When food access door 320 is in its open position, an operator can access the food basket 314 that is positioned within housing 312. Food basket 314 (see FIG. 6B) includes a perimeter frame 330 that is made of a deformable material such as silicone, along with a central portion 332 that may be a metal or other relatively rigid material with a grid pattern and/or perforated openings. In one embodiment, central portion 332 is a perforated or woven metal plate with multiple openings. Food basket 314 includes an extending handle 334 that can be grasped by the user to insert and remove the basket 314 from the housing 312. In this embodiment, the handle 334 will extend outside the housing 312 when the basket 314 is positioned therein.

As shown, basket 314 is positionable in the housing 312 in such a way that its silicone perimeter is sealed against a wireform or frame 370 within the housing 312 that holds up the basket. In particular, this embodiment of the basket 314 includes a lip 372 positioned over a top edge of the frame 370, thereby creating a seal around the perimeter of the basket 314 that will force air entering through the bottom of the basket to move through the food contained within the basket 314 and exit the top of the basket, as shown by arrows 374

Air fryer 310 includes a rotating arm 336 positioned beneath the food basket 314. The rotating arm 336 includes a roller 338 that pushes against one side of the bottom of the basket 314, thereby pushing that portion upwardly in the area of the roller (which is moving) and agitating the food contained in the basket. When the central portion 332 of the basket 314 is a rigid material, it will tilt upward in an area where the roller 338 is pushed against it, and this area will then tilt back down when the roller 338 moves to contact a different area of the central portion 332. Rotation of the arm 336 (and corresponding roller 338) can be driven by a motor to provide the desired amount of agitation for the basket 314. Alternatively, rotating arm 336 can be manually activated to agitate the food contained in the basket.

Air fryer 310 further includes at least one heater element 342 positioned inside an air duct 343. In this embodiment, four heater elements 342 are shown in the air duct 343 of the housing 312, but more or less than four heater elements can be used. The heater elements 342 can include quartz tube heaters or other types of tubular heaters, such as those described above relative to FIGS. 1 and 2. A fan 348 (e.g., a centrifugal fan) can also be provided generally adjacent to the heater elements to circulate the heated air.

Housing 312 further includes a water fill door 328 at the side opposite the side in which the basket is placed. Water fill door 328 is attached via a hinge to the base portion in order to provide an operator with access to an inner water tank 356. Water fill door 328 can also be provided with a handle, recess, or other feature that allows an operator to easily move it to access the water tank 356, when desired. Water tank 356 is configured so that steam is produced when its contents are sufficiently heated. This may be accomplished via an immersion boiler 358 positioned within the water tank 356, for example.

A steam tube 360 extends from the water tank 356 and is positioned so that steam exiting the water tank 356 is supplied in a preselected location within the housing 312 that provides a desired steam flow path. For example, steam can exit steam tube 360 at an end of the tube in the direction illustrated generally in FIG. 6A with arrow 364. In addition, steam ports 368 can be provided on either side of the fan vents, as desired.

The centrifugal fan 348 directs air out of vents either before, after, or during the time that steam is being directed as shown in the illustration. The speed of the fan 348 is controllable to allow for adjustment of the movement of the heated air along its path. The speed of this fan 348 can be directly or indirectly correlated to the amount of steam being produced in order to achieve a certain cooking of the food product. The air fryer 310 can be provided with automatic and/or manual settings to adjust these parameters

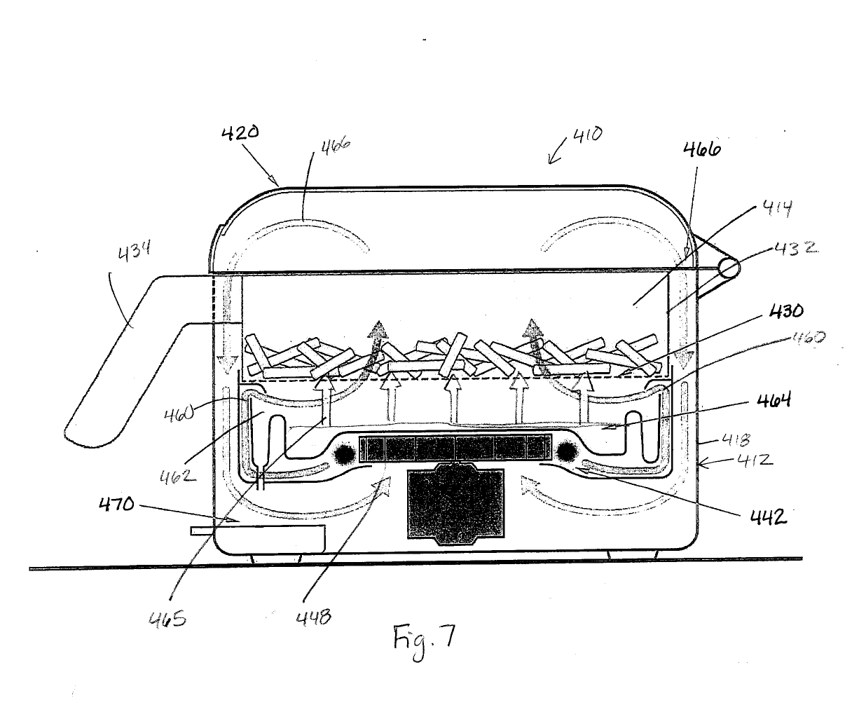

FIG. 7 is another exemplary embodiment of an air frying system 410 of the invention. Air fryer 410 includes a housing 412 that has a similar general configuration to the air fryer 210 of FIG. 5A in that it also includes a base portion 418 and a food access door 420 at the top of the device. All or portions of the food access door 420 can be transparent, translucent, and/or opaque. Air fryer 410 further includes a food basket 414 that includes a mesh or perforated bottom 430 from which side walls 432 upwardly extend. Portions of the side walls 432 can be mesh, perforated, and/or solid. Food basket 414 includes an extending handle 434 that can be grasped by the user to insert and remove the basket 414 from the housing 412. In this embodiment, the handle 434 extends outside the housing 412 when the basket 414 is positioned therein.

Air fryer 410 further includes at least one heater element 442 positioned adjacent to a fan 448 (e.g, a centrifugal fan) in the lower area of the fryer 410. For one example, a circular heater element 442 can be used. The fan 448 circulates air that is heated by the heater element 442 along a path generally illustrated by arrows 460 in order to force hot air up through the bottom of the basket 414. In addition, air can be pulled into vents along the housing perimeter, as is illustrated by arrows 466.

A cooking chamber 462 is positioned below the food basket 414 and above the fan 448, wherein the lower surface of cooking chamber 462 is contoured in such a way that a relatively flat surface extends over the top of fan 448 and a lower reservoir 464 extends below this surface. The lower reservoir 464 can be filled or partially filled with water and heated by the heaters 442 or in some other manner to create steam. Steam exits the reservoir 464 in a direction generally represented by arrows 465 to enter the bottom of the basket 414 and contact the food contained therein. An overflow channel can also be provided at a lower end of the housing 412 that drains into a drip tray 470.

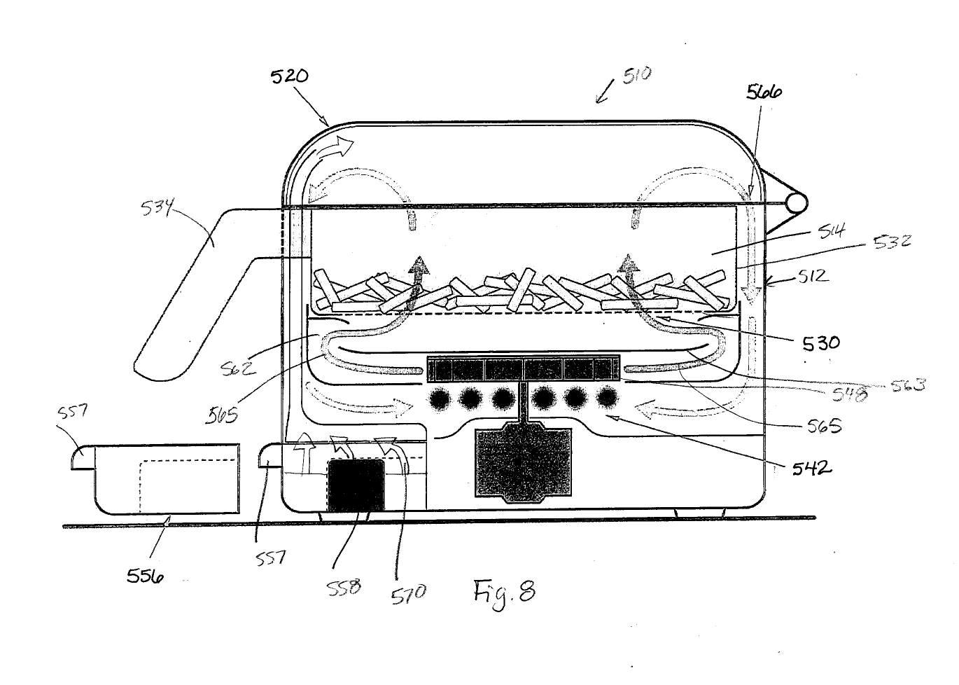

Finally, FIG. 8 illustrates another exemplary embodiment of an air frying system 510 that is similar in configuration to the air fryer 410 of FIG. 7. Air fryer includes a housing 512 having a base portion 518 and a food access door 520. All or portions of the food access door can be transparent, translucent, and/or opaque. Air fryer 510 further includes a food basket 514 that includes a mesh or perforated bottom 530 from which side walls 532 upwardly extend. Portions of the side walls 532 can be mesh, perforated, and/or solid. Food basket 514 includes an extending handle 534 that can be grasped by the user to insert and remove the basket 514 from the housing 512. In this embodiment, the handle 534 extends outside the housing 512 when the basket 514 is positioned therein.

Air fryer 510 further includes at least one heater element 542, and preferably includes multiple heater elements 542 positioned adjacent to a fan 548 (e.g., a centrifugal fan) in the lower area of the fryer 510. The heater elements 542 can include quartz tube heaters or other types of tubular heaters, such as those described above relative to FIGS. 1 and 2. A cooking chamber 562 is positioned below the food basket 514 and above the fan 548, with an optional plate 563 positioned generally above the fan and below the basket 514. The fan 548 circulates air that is heated by the heaters 542 into the cooking chamber 562 and along a path generally illustrated by arrows 565 in order to force hot air up through the bottom of the basket 514.

Air fryer 510 further includes a removable water tray 556 at its lower area that is provided with a handle 557 or another feature, such as a recess, that allows an operator to easily remove it from the housing 512 when desired. Water tank tray 556 is configured such that its contents can be sufficiently heated to produce steam. This may be accomplished via an immersion boiler 558 positioned within the water tray 556, for example. The steam exits the water tray 556 in a direction generally represented by arrows 570 so that the steam can enter the area of the cover 520 above the basket 514 and contact the food contained therein. In this embodiment, air is pulled into vents along the perimeter of the housing 512, as is illustrated by arrows 566.

Although the descriptions provided herein relative to the multiple embodiments are generally directed to systems that use both hot air and steam, it is contemplated that any of these systems of the invention may instead be used with only hot air or only steam, wherein the systems can be adjustable to turn off and/or adjust the quantity of the hot air and the steam added to the system. Such adjustability can be useful to provide different cooking capabilities for different food products and/or for different quantities of food products. It is contemplated that microprocessors or other control systems may be used to control the cooking cycles of the steam and/or hot air that is being used at any given time in the cooking process.

Although certain features are described generally herein relative to particular embodiments of the invention, it is understood that the features are interchangeable between embodiments to arrive at a single air frying system that includes features of different illustrated embodiments. It is further understood that although certain embodiments discussed above include the simultaneous use of steam and hot air, the cooking processes can instead include the use of steam in an initial step with a food product, such as with precooked or flash-frozen food items, then the steam can be evacuated or allowed to exit the device, and then the air frying step can commence. However, these steps can instead be performed in a different order and/or certain steps can be added, eliminated, or repeated, if desired. The amount of steam provided to the food products can be controlled and monitored to provide varying amounts of steam, depending on the food being cooked and the qualities desired for the end food product. The timing of when the steam is introduced within the system can also be controlled and monitored.

The present invention has now been described with reference to several embodiments thereof. The entire disclosure of any patent or patent application identified herein is hereby incorporated by reference. The foregoing detailed description and examples have been given for clarity of understanding only. No unnecessary limitations are to be understood therefrom. It will be apparent to those skilled in the art that many changes can be made in the embodiments described without departing from the scope of the invention. Thus, the scope of the present invention should not be limited to the structures described herein, but only by the structures described by the language of the claims and the equivalents of those structures.

What is claimed is:

1. An air frying system comprising:
a housing defining an inner chamber;
a food container positioned in the inner chamber;
an air heating and circulation system in communication with the food container; and
a steam supply and circulation system in communication with the food container, wherein the air heating and circulation system and the steam supply and circulation system are independently controllable for cooking a food product in the food container.

2. The air frying system of claim 1, wherein the food container comprises a basket with a plurality of openings that are in communication with at least one of the air heating and circulation system and the steam supply and circulation system.

3. The air frying system of claim 2, wherein at least a portion of a bottom surface of the basket comprises the plurality of openings.

4. The air frying system of claim 1, further comprising a rotatable carriage positioned in the inner chamber of the housing, wherein the food container is removably positioned in the rotatable carriage.

5. The air frying system of claim 1, wherein the food container is rotatable about a horizontal axis.

6. The air frying system of claim 1, wherein the steam supply and circulation system comprises a water tank and a water heating element for heating water contained in the water tank to create steam.

7. The air frying system of claim 6, further comprising a steam tube extending from the water tank, the steam tube comprising a distal end positioned to provide steam to a predetermined location within the inner chamber of the housing.

8. The air frying system of claim 7, wherein the predetermined location for steam delivery comprises an inside space of the food container.

9. The air frying system of claim 6, wherein the water heating element comprises an immersion boiler.

10. The air frying system of claim 1, wherein the air heating and circulation system comprises a fan system.

11. The air frying system of claim 10, wherein the fan system comprises a centrifugal fan.

12. The air frying system of claim 10, wherein the air heating and circulation system comprises at least one air heating element.

13. The air frying system of claim 10, wherein the at least one air heating element comprises one of a quartz tube heater, a wound mica heater, a halogen tube heater, a heating rod, and a tubular heater.

14. The air frying system of claim 1, further comprising a control system for monitoring and controlling at least one of a volume and a pressure of steam being provided to the food container.

15. The air frying system of claim 1, further comprising an automated control system for controlling the air heating and circulation system and the steam supply and circulation system.

16. The air frying system of claim 15, wherein the automated control system comprises a microprocessor.

17. A method of cooking food products, comprising the steps of:
adding at least one food product to a food container that is positioned in a housing of an air frying system, wherein the air frying system further comprises an air heating and circulation system and a steam supply and circulation system; and
activating at least one of the air heating and circulation system the steam supply and circulation system.

18. The method of claim 17, wherein the air heating and circulation system and the steam supply and circulation system are sequentially activated.

19. The method of claim 17, wherein the air heating and circulation system is simultaneously activated with the steam supply and circulation system.

20. The method of claim 17, wherein the step of activating at least one of the air heating and circulation system the steam supply and circulation system comprises activating both the air heating and circulation system the steam supply and circulation system
